(19) United States
(12) Patent Application Publication
(10) Pub. No.: US 2022/0382522 A1
(43) Pub. Date: Dec. 1, 2022

(54) SYSTEM AND METHODS FOR DEVELOPMENT OF COMPOSABLE AND CUSTOMIZABLE COMMERCE SOFTWARE

(71) Applicant: VTEX Commerce Cloud Solutions LLC, Ft. Lauderdale, FL (US)

(72) Inventors: Bernardo Heynemann Nascentes da Silva, Rio de Janeiro (BR); Bruno Henrique da Silva, Rio de Janeiro (BR); Tiago Lobato Gimenes, Rio de Janerio (BR); Guilherme Rodrigues, Rio de Janerio (BR); Geraldo Thomaz, JR., Rio de Janerio (BR)

(21) Appl. No.: 17/824,019

(22) Filed: May 25, 2022

Related U.S. Application Data
(60) Provisional application No. 63/193,770, filed on May 27, 2021.

(51) Int. Cl. G06F 8/20

(52) U.S. Cl. CPC G06F 8/20

(57) ABSTRACT

Systems and methods are described that allow maximum flexibility for users to develop simple or complex data processing applications for customization of B2B, B2C and marketplace commerce application software, platforms and extensions that are composable. In this development, applications operate in a distinct and separate application plane that is uniquely designed to be independent of the core program but leverages the underlying data structures and applications support processes. This capability is created through the provision of well-defined extension points in the core program. This improvement, preferably when combined with a microservices architecture, enables users to more easily and quickly produce and deploy customized applications as they will not alter or impact the core program or its upgradeability thereby allowing improved and continuous flexibility to modify commerce platform functionality to better meet evolving business needs.

### CROSS-REFERENCE TO RELATED APPLICATIONS

The present patent application claims benefit of Pending Patent Provisional Application No. 63/193,770, filed May 27, 2021.

### INCORPORATION BY REFERENCE

The disclosure made in U.S. Provisional Patent Application No. 63/193,770, filed May 27, 2021, is specifically incorporated by reference herein as if set forth in its entirety.

### TECHNICAL FIELD

The present invention relates to the development of software as a service (SaaS) and/or platform as a service (PaaS) systems, specifically for those systems used to enable business to business (B2B), business to consumer (B2C), and marketplace commerce business models, in a way that allows for businesses implementing, consuming from, or integrating with the SaaS and/or PaaS systems to embed additional application software (apps) into the SaaS and/or PaaS systems thus allowing them to extend the service. More particularly, the invention relates to enabling easier and faster development and deployment of composed and/or assembled and customized application components in a plane separate from a plane for core programs.

### BACKGROUND

Companies (e.g., users) purchase marketplace and commerce software with the primary objective of enabling digital commerce with their customers. Marketplace and commerce includes product promotion, digital cart and checkout, payment processing, order management, customer service and fulfillment. Companies (e.g., users) are seeking marketplace and commerce systems that provide the features to securely sell to and service their customers and business partners. However, business-specific requirements that diverge from a system's functionality as delivered from a software provider are common. The ability for users to introduce their unique changes into the system easily and quickly is necessary to meet constantly changing market demands.

Core program software and data processing/extension applications (apps) in current monolithic commerce platforms, whether on-premise or in a single-tenant cloud, are challenging, costly, and time consuming to modify, update, or deploy. Any changes to the core code (e.g., core programs) and/or apps require skilled programmers due to the fact that the core program and apps share the same application framework and access to persistent data, making them interconnected and therefore complex and co-dependent. These traditional configurations also limit users' flexibility to create new apps and/or to add functionality to existing apps, as each new app requires significant programming skill and effort to integrate successfully with the core program and other apps as well as to deploy.

Customizations of typical historical monolithic on-premises or single-tenant cloud installations utilize significant core code modifications which compound the complexity and challenge of making any changes and/or updates. Further, because of the interoperability of and interdependence or c-dependence between the core programs and the apps, system governance is difficult and takes more time as extensive testing has to be completed to verify that any modified app functions as desired and are compatible with and will not inadvertently impact any aspect of the core programs and/or other apps.

Due to the high level of effort to program, write, and/or update compatible apps, difficulties or challenges may be experienced when attempting to add or change functionality. As such, users either accept substandard apps that do not provide all the desired capabilities or wait for long development cycles, dictated by these traditional processes. Such examples decrease responsiveness, increase cost, and result in missed opportunities.

Deployment of new versions of apps in this model is challenging because the application developer rarely has an upgrade contract, so software versions tend to stay outdated as long as functionality remains. This lack of new versions blocks new features, increases maintainability costs, and may introduce future dependency malfunctions.

The interconnected nature of apps with the core program drives many commerce platform providers to offer apps with a minimum set of standardized functions that may partially address user needs. Due to limited software company and user resources, plus diminishing returns on those resources, software companies typically do not invest the time and expense to address unique user needs, so user requests aren't fully satisfied. Even if users have the programming skills, most software companies will not allow outside access to their core program due to concerns about maintaining the security and confidentiality of their proprietary technology as well as risks to other users if the core code is compromised. This lack of access causes difficulty when ensuring proper interoperability of user created apps.

Long and difficult development cycles for conventional systems translate into excessively long and unpredictable deployment times to migrate to new platforms, add functionality, or fix problems. These delays often result in user frustration and costly missed market opportunities.

Software companies are very hesitant to change core programs to better address user requests or custom requests, as these changes can have substantial negative ripple effects on each user's ability to understand the custom function and its interoperation with any other user's app. Any core program changes also impact the software company's ability to deploy new releases of the core program since, once it is customized, upgrades may result in unexpected and unstable behavior, as well as incompatibilities with other user apps.

Along with app changes, core program updates are also difficult and time consuming as such updates require confirming that any changes are compatible with any prior core program modifications, in addition to all other apps. Such confirmation delays the deployment of improvements needed to enhance the core program's stability, interoperability, and efficiency or expand its capabilities. The confirmation delays often result in costly missed opportunities.

While generic cloud multi-tenant platforms are available, those platforms do not include an embedded development platform that keeps applications separate from the core program and, consequently, do not provide the benefits of the systems described herein. Typical conventional systems run or execute program extensions that are interconnected with the program using external Application Program Interfaces (APIs). In addition, multi-tenant platforms that provide the ability to deploy apps either do so outside of the business domain of the SaaS service, which calls for integration and compatibility management, or limit extension and customization to a narrow solution space.

End users expect their commerce and marketplace software to be fast, available, scalable, efficient, and easily modified so it will be a more effective tool to make it easier for their customers to transact and to ultimately help them achieve their business goals. Clearly current marketplace and commerce software technology is far from meeting this objective.

### SUMMARY OF INVENTION

The benefits from the systems described herein result from the separation of the application plane from the core program (e.g., the VTEX architecture) or core program plane, thus enabling application extensions to be created and modified without impacting the core programs and, conversely, allowing changes or updates to the core program to not affect apps in the application plane. The combination of the core program plane, including the core programs, and the application plane, including apps, are delivered as a packaged set of SaaS and/or PaaS capabilities.

In an embodiment, a system may include the core platform. The core platform may be designed or developed from the ground up with specified, well-defined extensions points and a configuration protocol that assumes app extensions or enterprise level app extensions. The app extensions or enterprise level app extensions are enabled due to the unique combination of the standardized microservices architecture, in addition to the separation of the application plane from the core program plane or core programs. The result is a multi-tenant SaaS (Software as a Service) platform integrated with a tenant-specific PaaS (Platform as a Service) that is delivered as a single packaged business application platform. This platform, e.g., VTEX TO, is a hybrid approach that allows for or enables custom apps to be written “on platform” in a way that leverages the benefits of multi-tenant services while providing the flexibility of custom application development with the typical SaaS characteristics of scalability, seamless releases plus easier and more rapid customization and upgrades.

Those skilled in the art will appreciate the above stated advantages and other advantages and benefits of various additional embodiments by reading the following detailed description of the embodiments with reference to the below listed drawing figures.

### BRIEF DESCRIPTION OF DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1A and FIG. 1B is a schematic diagram of a multi-tenant SaaS with an integrated, tenant specific PaaS, according to one aspect of the present disclosure.

FIG. 2A and FIG. 2B are schematic diagrams of merchant managed composable enterprise solutions, according to one aspect of the present disclosure.

FIG. 3 is a schematic diagram of a multi-tenant SaaS with external app model, according to one aspect of the present disclosure.

FIG. 4 is a schematic diagram of a monolithic single tenant system, according to one aspect of the present disclosure.

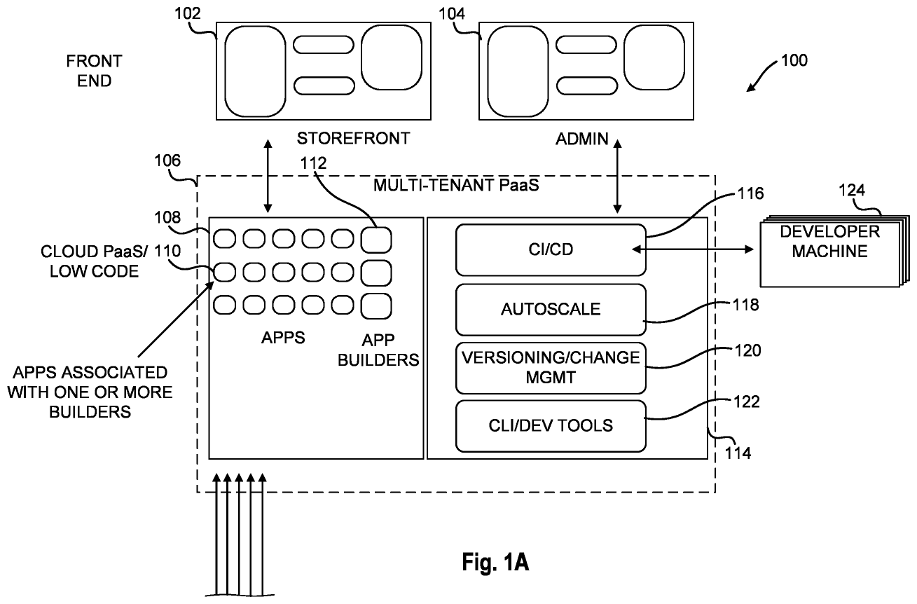

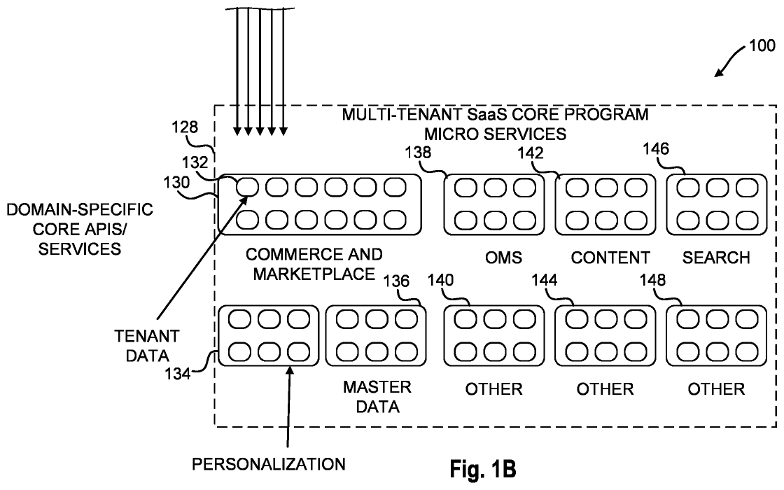

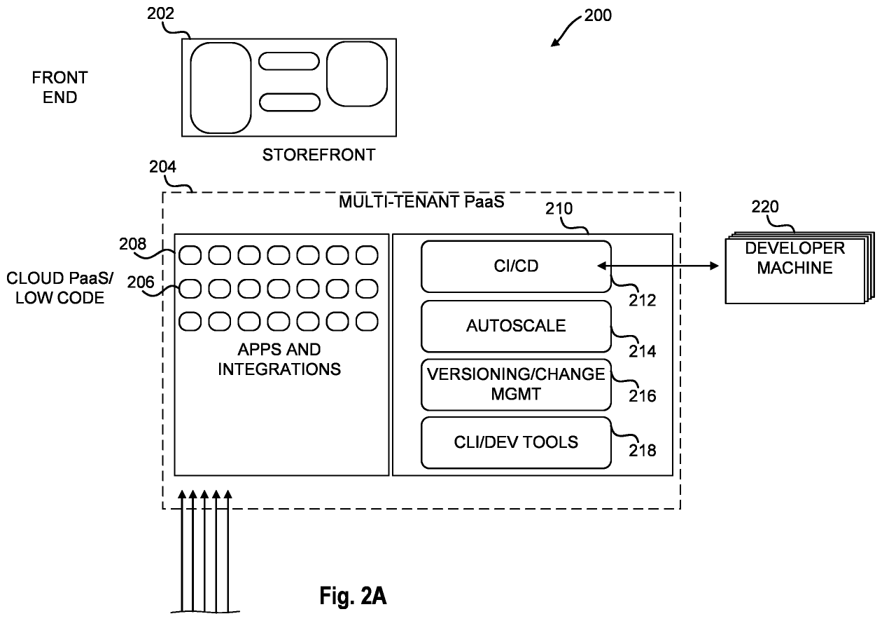

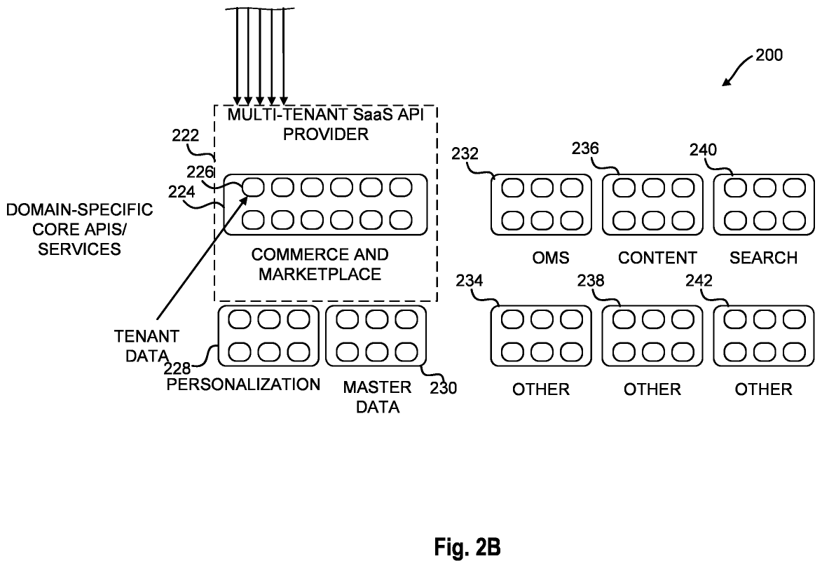

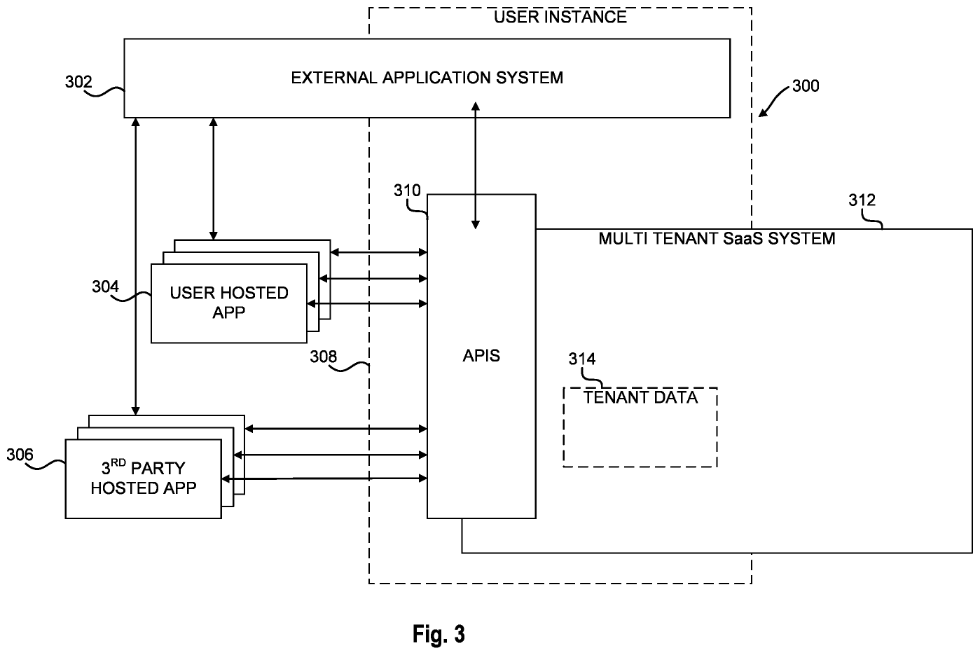

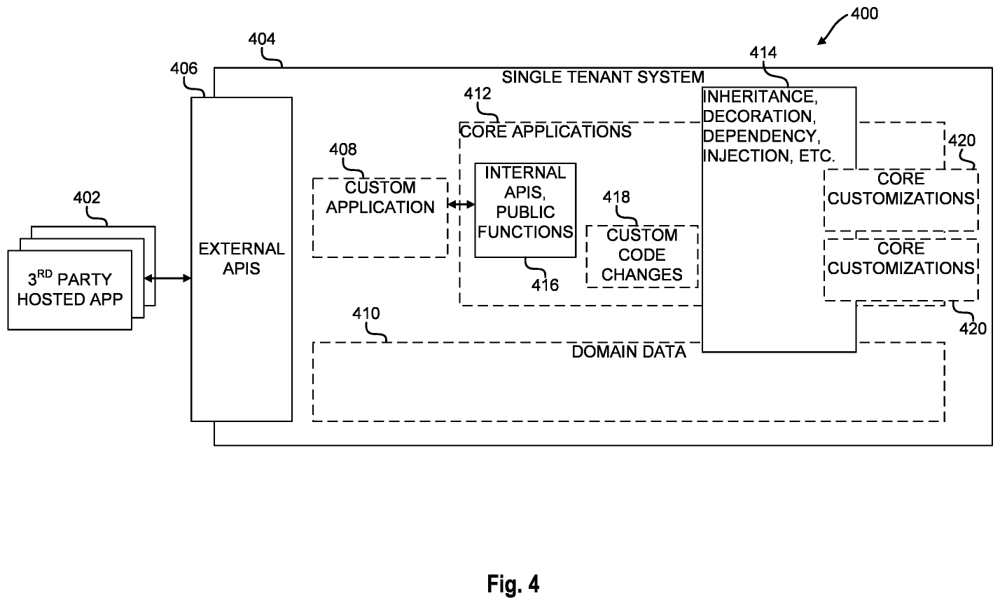

The use of the same reference symbols in different drawings indicates similar or identical items.

### DETAILED DESCRIPTION

The following description in combination with the figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

By leveraging a microservices architecture of the core program platform or core platform, in addition to the use of well-defined core program extension points with a configuration protocol that separates the application plane from the core programs or core program plane, a low code, rapid development platform has been created that allows and promotes easy function composability (e.g., assembly) and customization without impacting the core programs or core program platform. The microservices architecture may work with and may be dependent on the separation of the core programs or core program plane from the application plane. The first-class connection between core programs or core program plane and application plane is provided through default core program clients offered in the app extension environment and a well-defined configuration protocol, built in a declarative way, so the core programs or core program plane can be configured by app extensions.

In addition, apps implementing new services can be written in a way that is decoupled from each apps many user-specific implementation details through the use of configuration apps. The configuration apps may provide additional configuration details to be leveraged by the service app, which, in embodiments, can include web services, or servers, or other applications having HTTP endpoints or which can be configured to listen to platform events for processing core programs. App extensions are developed using a low code, core aware and compatible development tool set. By following this approach, apps are built on top of the existing core program in a separate plane using these well-defined extension points to ensure compatibility between the core programs and each app while maximizing the capability to easily and quickly modify either the core program or apps without impacting platform performance or platform evolution. Besides the regular input for processing, the service app can be programmed or adapted to can fetch configurations based on other installed apps and change its behavior accordingly. This makes the service highly customizable depending on the configuration apps a customer has installed.

This approach enables each app extension to perform as desired without compromising the core program integrity which allows developers working on behalf of platform users to rapidly create functional extensions, integrations, and modifications leveraging the microservice APIs. By making these APIs consistent and enforcing a version contract obeying semantic versioning, the development platform provides a way to rapidly create new functions that leverage those API connection points while ensuring compatibility with the core program.

Apps can extend the core programs in multiple ways including web “front-end” components and services requiring server computation, as well as administration apps to configure aspects of the entire software package. A separate subsystem within the platform called “builders” (e.g., for example, compilers) is responsible for processing, validating, and forwarding an app's block of code to a runtime or framework within the packaged SaaS platform that is responsible for executing it. Apps can be associated with one or more of these builders, including builders responsible for handling file based assets, builders for storefront or admin front-end applications, builders for text localization, builders for GraphQL queries, builders for javascript frameworks (e.g., such as React), and builders for server-side code execution. Such a system of builders may be called or referred to as the “Builder Hub”, which can also be extended to add more functionality. Apps that compose or are composed by multiple builders can provide a broader functional scope all encapsulated within a single app. For example, an app might use a service builder, a storefront builder, a messages builder, and/or a documentation builder to have a fully localized, well documented, storefront component that may store, based on the storefront's own services, a customer's purchase wishlist, thus providing a feature that may not be delivered by the core system.

A further aspect of the systems described herein is the provisioning of the capabilities described to a user via a virtual serverless platform.

By having VTEX IO app modifications deployed using a software container deployment platform in an infrastructure isolated from core services infrastructure, the system eliminates or reduces global scalability and reliability issues compared to more monolithic deployment models. The containers may be orchestrated in multiple and/or redundant clusters that provide both reliability and performance. Apps may be deployed with unique infrastructure configurations that are appropriate for the app's usage. To a certain extent, apps may define an app's specific deployment environment settings to better fit the app's processing profile, although the platform may retain authority over these settings and change or update the settings. The configuration for each container cluster may be tuned to better fit each app's needs, which may further enhance overall system performance. A storefront service, for example, may specify very small or low latency and high availability and may, therefore, be deployed in a different container cluster than an admin application, which may include or have a different operating profile.

Apps installed into the environment may have configured dependencies on other apps and/or core programs. The platform may handle such dependencies by automatically installing dependent apps, or in cases where manual user app install approval is specified, for example, when installation of a paid third party app specifies a dependent app installation process.

A robust security framework may be embedded within the system that allows for the granting of permissions to resources or roles within the platform. Such permissions create a fine-grained set of policies, which the platform may utilize to restrict and authorize specific actions roles or resources which may be performed. The infrastructure routing system may verify and block every outbound proxy attempt that does not meet specified policies. Such a process may ensure that the application states what kind of client data to access (e.g. catalog, pricing, orders, etc.) and that the application won't leak that data outside the declared allowable endpoints.

A developer command line interface (CLI), specific to configuring, developing on and deploying to the platform may be provided as part of the SaaS platform. The CLI may integrate source code on a user's local computer with the user's specific tenant instance of the SaaS platform. The CLI offers the ability, in a development context, to automatically deploy changes to local source code upon file changes that can then be immediately or substantially immediately reflected in the end user apps, including web applications built with the platform. Additional tools in the CLI may include app installation, app publishing, and deployment.

The systems described herein may also provide a mechanism for app monetization by third party app publishers and an installation prompt process for approving installation. For example, the CLI can be configured to install apps, but in some embodiments, third party app publishers can be allowed or granted permissions to enable them to configure features such as billing options for theirs apps. Such configuration options can be subscription based or billed according to usage, which can provide an extra step when installing the app to process the purchase.

VTEX IO may be divided into multiple orchestrated container clusters with each configured for different use cases. Each orchestrated container cluster has a set of containers that host all the services that are specified for every tenant's full operation.

Applications may be stored in an application registry service that keeps track of their versions and installation map, so that the system knows exactly what applications are installed in what versions and what vendors. The registry itself may enable VTEX IO to composably create a tailor-made environment while reusing services and their configurations throughout different tenants.

Applications built on VTEX IO may also leverage from native runtimes that simplify the development of:
A. backend applications (e.g., applications using NodeJS and .NET), by dealing with storage plugging, configuration versioning, request proxying, caching strategies, request retrial, and security policies management; and
B. frontend applications (e.g., using React), by offering isolated component development that may rely on provided context from other components (e.g., a wishlist component application, may rely on a minicart (e.g., developed by another), that may inform whenever an item from the list has been already purchased or added to cart).

Both backend and frontend applications' runtimes may enable the creation of VTEX IO's Store Framework, a powerful storefront framework tool that enables composability of commodity frontend components such as: banners, minicarts, login, account management, and/or third party apps that empower businesses to be creative and have their specific uses attended, e.g., such as an integration for a pharmacy benefit management (PBM). The systems functionality may utilize GraphQL queries that determine a user's page template, and that fetch the app's component's assets and renders them in the same React runtime. In such embodiments, a whole set of components built by many different vendors and developers may compose the same page. For performance, the Store Framework's page may also be rendered server side, in which case pages may be fetched as unified and minified assets that may be stored in CDN.

While the capability described herein has been described for an ecommerce environment, a person skilled in the art may apply the same approach to modify any SaaS single code multi-tenant platform to achieve the same benefits and/or results. For example, in the domain of Enterprise Resource Planning (e.g., ERP, or entity relationship management) software, where specific business requirements of the user demand changes to the core program platform, the system described herein may be applied to allow extensions and customizations to be more easily and quickly deployed and then consumed as a packaged SaaS platform. Other applicable domains may include, but not be limited to, marketing, customer relationship management, and digital experience management platforms.

### Alternate Approaches

Local (e.g. PC, Mac) Environment Based Development:

Using a downloaded data model of the core commerce function, APIs may be exposed in GUI form, making manipulation and extension easier due to the graphical nature of the interface. Such an approach leverages the power of a GUI-based approach to simplify the development effort. Such an approach may include the use of an intermediate development step utilizing a server onto which a development team may load modifications, and then coordinate the components before promoting into a stage or pre-production instance. Further, local environments may include download models to be updated regularly.

Jamstack Based Approach:

An approach may include using local environment based development powered by a powerful CI/CD in a GIT based workflow to automatically deploy and preview content before publishing it. However, this approach may not allow total control of the platform (e.g., configuration, backend, code) via a single, integrated solution. Some intermediaries may be utilized to accomplish such tasks, like serverless functions or other bots.

Macro 4GL Approach (Fourth Generation Language)

An approach may include using macros to automatically generate strings of code in a commerce environment to shorten the development effort. Such an approach allows developers to string together multiple macros to build key functions of the core Commerce. These macros may be delivered and maintained by the original developer of the core to ensure that the macros properly leverage the Core APIs. Components in such an approach may be coordinated into a single solution. According to various embodiments, the systems and methods described can enable the production of marketplace and commerce software with multiple benefits, such as:
Promoting much faster deployment of the initial platform with significantly reduced go live times.
Making it easier to modify and create apps enabling more and faster customization of the commerce platform to better meet ever changing business demands.
Eliminating potential issues/concerns as to impacts on the core program whenever apps are modified by separating the core program from the application plane. Thus giving users more control by allowing more flexibility to modify and/or create their own apps. Due to the reduced complexity, it also allows app development by less skilled users who do not have high level programming skills.
Allowing platform users to modify the underlying back office commerce administrative panel so users can simplify back office operations by removing or hiding any irrelevant functions which makes it easier to manage and learn.
Allowing quicker and easier app updates with faster, seamless and more stable deployment.
Creating an ability to customize SaaS apps without affecting upgrades.
Allowing quicker, easier and essentially continuous core program updates with little to no downtime and minimal impact on platform performance.
Shortening delivery time and effort for new and/or updated apps by greatly reducing the development complexity.
Allowing substantially continuous upgrades with little to no downtime and minimal impact on platform performance
Increasing flexibility by allowing use of many diverse apps by eliminating typical cross-application conflicts.
Coordinating apps from different providers/developers as incorporated apps are independent of programming used to develop them.
Adding apps from different providers to the commerce engine changes just the required pieces to insure functionality.
Other features and/or benefits also can be provided.

The foregoing description generally illustrates and describes various embodiments of the present disclosure. It will, however, be understood by those skilled in the art that various changes and modifications can be made to the above-discussed construction of the present disclosure without departing from the spirit and scope of the disclosure as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present disclosure. Accordingly, various features and characteristics of the present disclosure as discussed herein may be selectively interchanged and applied to other illustrated and non-illustrated embodiments of the disclosure, and numerous variations, modifications, and additions further can be made thereto without departing from the spirit and scope of the present invention as set forth in the appended claims.

What is claimed is:

1. A system for providing a low code, rapid deployment application development platform, the system comprising:
a multi-tenant software as a service (SaaS) core program micro services comprising one or more of domain-specific core programs, APIs, and micro services; and
a multi-tenant platform as a service (PaaS) connected to the multi-tenant SaaS core program micro services and comprising:
one or more applications, and
one or more development tools configured to manage and update the one or more applications and to generate one or more new applications, wherein the multi-tenant PaaS defines an application plane and the multi-tenant SaaS core program micro services defines a core program plane, and wherein the application plane and the core program plane are separate and decoupled to thereby enable (1) updates and additions to the application plane independent of updates and additions to the core program plane and (2) updates and additions to the core program plane independent of updates and additions to the application plane.

2. The system of claim 1, further comprising front end components and admin components.

3. The system of claim 1, wherein the one or more development tools includes one or more builders.

4. The system of claim 3, wherein the one or more builders include one or more of a builder for file based assets, a builder for storefront applications, a builder for admin front-end applications, a builder for text localization, a builder for GraphQL queries, a builder for javascript frameworks, and a builder for server-side code execution.

5. The system of claim 4 wherein each one of the one or more applications may be associated with one or more of the one or more builders.

6. The system of claim 1, further comprising a virtual serverless platform, and wherein the one or more development tools, the one or more applications, domain-specific core programs, APIs, and micro services are provided to a user via a virtual serverless platform.

7. The system of claim 1, further comprising one or more containers, and wherein the one or more containers include the multi-tenant PaaS and the multi-tenant SaaS core program micro services.

8. The system of claim 1, further comprising a security framework configured to grant permissions to one or more of resources or roles.

9. The system of claim 8, further comprising an infrastructure routing system, and wherein the infrastructure routing system verifies outbound proxy attempts and blocks proxy attempts that do not meet policies.

10. The system of claim 1, wherein the multi-tenant SaaS core program micro services includes a command line interface (CLI) configured to enable development and deployment of applications.

11. A system for providing a low code, rapid deployment application development platform, the system comprising:
a multi-tenant software as a service (SaaS) API provider comprising one or more of domain-specific core programs, APIs, and micro services; and
a user managed application cloud connected to the multi-tenant SaaS core program micro services and comprising:
one or more applications, and
one or more development tools configured to manage and update the one or more applications and to generate one or more new applications, wherein the user managed application cloud defines an application plane and the multi-tenant SaaS core program micro services defines a core program plane, and wherein the application plane and the core program plane are separate and decoupled to thereby enable (1) updates and additions to the application plane independent of updates and additions to the core program plane and (2) updates and additions to the core program plane independent of updates and additions to the application plane.

12. The system of claim 11, wherein the one or more development tools include one or more of a continuous integration, continuous delivery, and continuous deployment (CI/CD) tool, an autoscale tool, a versioning and change management tool, a CLI or other development tool.

13. The system of claim 11, further comprising a builder hub, wherein the builder hub is defined by the one or more development tools, and wherein the functionality of the builder hub is extendable.

14. The system of claim 11, wherein one of the one or more applications are deployed with infrastructure configurations suitable for the one of the one or more applications usage.

15. The system of claim 11, wherein each one of the one or more applications include a definition of specific deployment environment settings.

16. The system of claim 11, wherein the multi-tenant SaaS API provider and the user managed application cloud define one or more of a business to business model, a business to consumer model, or a marketplace commerce business model
